(19) United States
(12) Patent Application Publication
(10) Pub. No.: US 2019/0101380 A1
(43) Pub. Date: Apr. 4, 2019

(54) FREQUENCY MODULATED MULTIPLE WAVELENGTH PARALLEL PHASE SHIFT INTERFEROMETRY

(71) Applicant: PHOTONICSYS LTD., Wahat Alsalam - Neveh Shalom (IL)

(72) Inventors: Ibrahim ABDULHALIM, Neveh Shalom (IL); Michael NEY, Beer Sheva (IL)

(73) Assignee: B.G. NEGEV TECHNOLOGIES AND APPLICATIONS LTD., AT BEN-GURION UNIVERSITY, Beer Sheva (IL)

(21) Appl. No.: 16/086,796

(22) PCT Filed: Mar. 16, 2017
(86) PCT No.: PCT/IL2017/050335

§ 371 Date: Sep. 20, 2018

Related U.S. Application Data
(60) Provisional application No. 62/311,438, filed on Mar. 22, 2016.

(51) Int. Cl. G01B 11/24; G01B 9/02

(52) U.S. Cl. CPC G01B 11/2441; G01B 2290/70; G01B 9/02007; G01B 9/02002

(57) ABSTRACT

Herein is provided a simplified method for performing multiple wavelength phase shift interferometry measurements that is implemented by modulating each of the monochromatic light sources with a different carrier frequency, combining them to a single beam, detecting all wavelengths simultaneously using the same detectors and separating them via Fourier analysis and demodulation of the data. This approach offers both a simplification to the optical system and reduces the duration of time required to perform the multiple wavelength measurement, based on a simple data extraction algorithm decoding the information for each wavelength. When combined with the parallel phase shift orthogonal polarization interferometric microscopy this method provides fast, stable, high precision 3D imaging and displacements sensing. Also disclosed are embodiments of optical systems designed to carry out the method.

### FIELD OF THE INVENTION

The invention is from the field of optics. Specifically the invention is from the field of phase shift interferometry.

### BACKGROUND OF THE INVENTION

Phase shift interferometry (PSI) is a well-established optical technique enabling high resolution non-contact and fast measurement of the distance between an object and some arbitrary plane perpendicular to the optical axis of the system. Based on this capability, PSI enables both tracking and analyzing the time dependent relative position of an object at a single point along the optical axis using a single pixel detector, and the three dimensional (3D) topographical mapping of an object's surface either in a single shot using an array of detectors or by scanning its surface using a single pixel detector. Such capabilities are of great importance and have applications in many scientific fields and in industry requiring fast high resolution surface mapping or motion tracking/vibrometry, such as the semiconductor industry, micro-electronics industry, biomedical imaging etc.

In PSI the relative position of the measured points on the surface of the object is extracted from the phase of the interference signal, which is extracted from several (i.e. 3-4) phase shifted interference signals obtained by measurements that are performed sequentially or in parallel. Since the phase can only be determined up to multiples of 2π, the change in an object's relative position or changes in its topography can be determined with a certainty only for differences in position that induce less than 2π change in the phase. In an optical system relying on a single wavelength λ and reflection measurement geometry, this 2π phase change translates to differences in position that are up to only λ/2 which is relatively short for optical wavelengths. This limitation cripples the ability to measure topographies with large height variability and high speed motions. One of the approaches to resolve this problem is using phase unwrapping algorithms; however they are limited in their accuracy. However, this limitation can be overcome by performing the interferometric measurements using several wavelengths (multiple wavelength PSI), either in parallel or sequentially, and combining them to yield an effective wavelength also known as a beat wavelength which is much longer than each of the wavelengths used and can thus lead to better performance even up to several orders of magnitude. This process and technique have been presented and discussed in U.S. patent application Ser. No. 15/260,398 entitled “Multiple Wavelengths Real Time Phase Shift Interference Microscopy” to the inventors of the present invention.

PSI systems using several wavelengths for topography or movement measurements are complicated optical systems that require several detectors and complementary optical equipment in order to measure sequentially or in parallel the phase shifted interferometric signals for each of the wavelengths in order to extract the required phase information. In the sequential measurement, the interferometric signals should be measured for the different phase shifts and then for each wavelength—this can be time consuming and can considerably harm the accuracy of the measurement as the object moves between measurements in addition to the obvious implication on the measurement rate. In the parallel detection approach, the different phase shifted interferometric signals should be measured simultaneously for the different wavelengths and for the different phases for each of them, requiring a large number of detectors and optics for the separation or extraction of the different wavelengths.

It is therefore a purpose of the present invention to provide PSI systems using several wavelengths that are configured to be used with a simplified method for performing the multiple wavelength measurement.

Further purposes and advantages of this invention will appear as the description proceeds.

### SUMMARY OF THE INVENTION

In a first aspect the invention is a method for performing multiple wavelength phase shift interferometry (PSI). The method comprises:
a) providing at least one light source, wherein all light sources together provide N beams of monochromatic light at N distinct wavelengths, wherein N≥2;
b) modulating each of the N monochromatic light beams with a different carrier frequency;
c) combining the N monochromatic light beams into a combined light beam comprised of the N wavelengths;
d) passing the combined light beam through an interferometer;
e) detecting the combined light beam output signal of the interferometer using at least one detector configured to detect all N wavelengths;
f) separating, by a process of frequency domain demodulation, the interferometric signal output by the at least one detector into N signals, each containing information related to a different one of the wavelengths;
g) repeating steps “e” to “f” for M different specific phase shifts for all N wavelengths produced by phase modulation optics; and
h) processing the M×N signals to extract phase information for optical path difference calculations and phase unwrapping.

In embodiments of the method at least two of the N wavelengths originate from the same light source and their beat modulation frequencies are chosen to be much higher than the detector cutoff frequency.

In embodiments of the method the process of frequency domain demodulation comprises one of:
a) Using N electronic band pass filters; and
b) Fourier analysis.

In an embodiment of the method:
a) in step “d” the interferometer is a two beam phase shift interferometer;
b) a single detector configured to detect all N wavelengths is used to detect the combined light beam output signal of the interferometer; and
c) in step “g” the phase modulation optics are located in the two beam phase shift interferometer.

In an embodiment of the method:
a) in step “d” the interferometer is an orthogonally polarized phase shift interferometer;
b) between step “d” and step “e” the combined light beam output signal of the interferometer is passed through a beam splitting unit that comprises achromatic waveplates, polarizers and beam splitting optics that split the combined light beam into M different phase shifted channels;
c) in step “e” the combined light beam is detected with M detectors one for each of the M channels;
d) step “f” is carried out separately for the output signals from each of the M detectors; and
e) step “g” is not carried out.

In an embodiment of the method:

a) in step “d” the interferometer is an orthogonally polarized phase shift interferometer;

b) in step “e” the combined light beam output signal of the interferometer is detected by a segmented detector comprised of M segments, wherein a polarizer and a phase retardation mask, each shifting the phase by a different amount, are located in front of each segment of the detector;
c) step “f” is carried out separately for the output signals from each of the M segments; and
d) step “g” is not carried out.

In a second aspect the invention is a system for performing multiple wavelength phase shift interferometry (PSI). The system comprises:

a) at least one light source, wherein all light sources together provide N beams of monochromatic light at N distinct wavelengths, wherein N≥2;
b) components configured to modulate each of the N monochromatic light beams with a different carrier frequency;
c) beam combining optics that combine the N monochromatic light beams into a combined light beam comprising the N wavelengths;
d) an interferometer;
e) at least one detector configured to detect all N wavelengths in the combined light beam output signal of the interferometer;
f) at least one frequency domain demodulation unit configured to separate the interferometric signal output by the at least one detector into N signals, each containing information related to a different one of the wavelengths;
g) phase modulation optics configured to produce M different specific phase shifts for all N wavelengths; and
h) a processor and display unit comprising software algorithms and processing, memory, and display components configured to process the M×N signals to extract phase information for optical path difference calculations and phase unwrapping.

In embodiments of the system the frequency domain demodulation unit comprises one of:
a) N electronic band pass filters; and
b) a processor and software configured to perform Fourier analysis.

In embodiments of the system the frequency domain demodulation unit and the processor and display unit are implemented as a single combined unit that shares processing, memory, and display components.

In embodiments of the system at least two of the N wavelengths originate from the same light source and their beat modulation frequencies are chosen to be much higher than the detector cutoff frequency.

In an embodiment of the system:
a) the interferometer is a two beam phase shift interferometer;
b) the at least one detector is a single detector; and
c) the phase modulation optics are located in the two beam phase shift interferometer.

In an embodiment of the system:
a) the interferometer is an orthogonally polarized phase shift interferometer;
b) a beam splitting unit is located after the interferometer, the beam splitting unit comprising achromatic waveplates, polarizers and beam splitting optics that split the combined output beam from the interferometer into M different phase shifted channels, each channel comprising all N wavelengths having the same phase;
c) the one or more detectors are M detectors, each detector configured to detect all N wavelengths in a different one of each of the M channels; and
d) the at least one frequency domain demodulation unit comprises one of:
   i) M frequency domain demodulation units, one for each channel; and
   ii) one frequency domain demodulation unit configured to carry out the demodulation for signals from all M channels.

In an embodiment of the system:
a) the interferometer is an orthogonally polarized phase shift interferometer;
b) the one or more detectors is a segmented detector comprised of M segments, wherein a polarizer and a phase retardation mask, each shifting the phase by a different amount, is located in front of each segment of the segmented detector; and
c) the at least one frequency domain demodulation unit comprises one of:
   i) M frequency domain demodulation units, one for each segment; and
   ii) one frequency domain demodulation unit configured to carry out the demodulation for signals from all M segments.

In this embodiment a polarization mask, which comprises polarization axes each of which is oriented at a different angle, can be located in front of each segment of the segmented detector in place of the polarizer and the phase retardation mask. The polarization mask comprises polarization axes having at least three orientations in each segment. For example the at least three orientations can be either 0, 45 and 90 degrees; or −45, 0 and 45 degrees; or 30, 60 and 120 degrees; or other combinations.

In another variation of this embodiment the segmented detector is a parallel detector or camera with a polarization mask in front of its photo sensing pixels. The polarization mask is divided into regions of 4 pixels, wherein the polarization mask comprises a polarizer having a different orientation for each of the 4 pixels. The orientations can be, for example, 0, 45, −45, and 90 degrees or other combinations.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 schematically illustrates an embodiment of a system that uses a single detector on a regular platform of a two beam phase shift interferometer to carry out the method of the invention;

FIG. 2 schematically illustrates an embodiment of a system that uses three separate detectors and an orthogonally polarized phase shift interferometer to carry out the method of the invention; and

FIG. 3 schematically shows an embodiment of a system that uses a four segment detector to carry out the method of the invention.

### DETAILED DESCRIPTION OF EMBODIMENTS OF THE INVENTION

Herein is provided a simplified method for performing multiple wavelength PSI measurements that is implemented by modulating each of the monochromatic light sources with a different carrier frequency, combining them to a single beam, detecting them all using the same detectors and separating them via Fourier analysis and demodulation of the data—thus performing the detection of all wavelengths simultaneously and by using the same detectors. This approach offers both a simplification to the optical system and reduces the duration of time required to perform the multiple wavelength measurement, based on a simple data extraction algorithm decoding the information for each wavelength.

In PSI, a two beam interferometer is normally used to produce the interference pattern of a sample positioned in one of the interferometer arms. In such an interferometric system a continuous monochromatic source with relatively constant amplitude is used. The reflected interference signal's intensity from each point of the sample can be described by a biased harmonic behavior described in equation 1:

I=B+A cos ϕ (1)

Wherein, B is the bias or DC level, A is the envelope of the interferometric signal and φ is its phase. The interference phase is related to the optical path difference (OPD) between a given point on the sample and its respective point of the reference mirror placed in the second arm of the interferometer, and it encodes the relative distance of the point relative to a plane with equal distance to the length of the interferometer arm holding the mirror. In order to extract the phase from the interferometric signal, using several (here 3) phase shifted signals, as can be seen in equations 2 and 3, where i=1,2,3 stands for the three phase shifted signals.

Iᵢ=B+A cos(ϕ+(i−1)π/2) (2)

ϕ=tan⁻¹[(I₁+I₃−2I₂)/(I₁−I₃)] (3)

However, such measurements are limited in their ability to unambiguously determine the OPD and therefore the distance between the sample point and the reference mirror plane, as the intensity signal is a harmonic signal with a phase of φ which is related to the OPD as described in equation 4, and is therefore limited to phase differences of 2π, which translates in reflection geometry to OPD of λ/2.

$$φ = \frac{2 π}{λ} \cdot OPD \qquad ( 4 )$$

When the sample has height variations larger than λ/2, the distance or 3D topography of the sample cannot be determined without ambiguity since the extracted phase values are wrapped by 2π modulus. In order to reconstruct the 3D shape of the sample's surface i.e. the distance between two adjacent points on its surface or the distance that the same point has moved along the optical axis of the system between measurements, either a phase unwrapping algorithm must be implemented or a utilization of 2 (or more) wavelengths for measurement. For multiple wavelengths, the interference signal's intensity of equation 2 is measured for all wavelengths separately and for each of the phase shifts, and using a combination of the phases calculated for each, one can extract the OPD for higher height variations using the technique presented in the previously referenced U.S. Ser. No. 15/260,398.

In order to achieve this extraction, for example for 3 wavelengths, an overall of 9 interferometric signals have to be taken for a single interferometric measurement of the sample—3 for each phase shifted interferometric signal and 3 for each wavelength. This can be achieved by taking them sequentially, in parallel or in some hybrid of these—each option requiring a different number of detectors or with varying measurement duration until the acquisition of the data required for a single shot of interferometric measurement is completed. This process is to be repeated if the sample changes its surface shape, or if it is in motion and its movement is being analyzed by the system such as in vibrometry.

Since either a large number of sequential measurements or a large number of detectors is required for a single interferometric measurement, the inventors have found a method of minimizing the number of required detectors, simplifying the optical setup and possibly shortening the measurement time to a single shot. This is achieved by combining the concept of parallel phase shift interferometry enabling the measurement of the 3 phase shifted signals in parallel by 3 separate detectors simultaneously, and performing the measurement of the different wavelengths simultaneously on the same detectors instead of multiplying the number of detectors by 3 or taking the measurements sequentially.

A single shot measurement can be achieved by using physical band pass filters to separate the carrier frequencies (and thus wavelengths). In the case of frequency separation by Fourier analysis it might be necessary to buffer several measurements to extract the Fourier signal using a sequence of measurements used for a discrete Fourier transform (DFT). Alternatively a sliding window FT can be performed, in which case it is necessary only to buffer samples at the beginning of the measurement and then output a position measurement at each sampling time of an analog-to-digital converter.

In all cases measurement time shortening is achieved by the fact that no change in the system is performed, such as a change of source wavelength or phase retardation such as in sequential measurements.

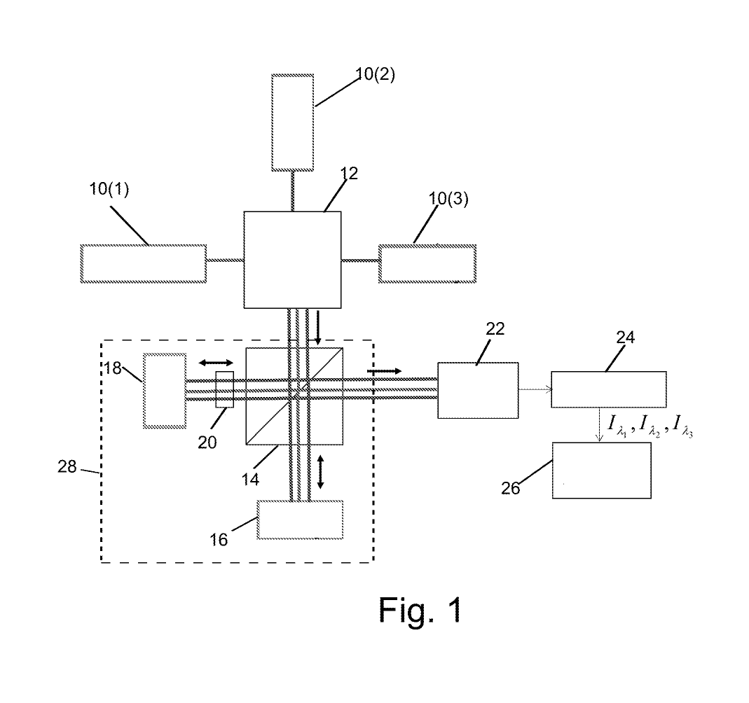

FIG. 1 schematically illustrates an embodiment of a system that uses a single detector on a regular platform of a two beam phase shift interferometer for carrying out the method of the invention. In this embodiment light at wavelengths λ(1), λ(2), and λ(3) emitted by three monochromatic light sources 10(1), 10(2), and 10(3) are each modulated respectively by three well separated and different frequencies f(1), f(2) and f(3). The output intensity of each light source has the form shown in equation 5, where I_{sλk}(t) stands for the time dependent intensity of the modulated source with wavelength λₖ, modulation frequency fₖ, and unmodulated intensity of I_{λk}.

I_{s,λ}_{ₖ}(t)=/I_{λ}_{ₖ}·sin(2πfₖt) (5)

The sources are then combined by beam combining optics 12 into a single beam that functions as the light source for two beam phase shift interferometer 28. The combined beam travels to beam splitter 14 in interferometer 28 wherein part of the beam passes to a sample 16 mounted on a moveable stage. The other part of the combined beam passes through phase modulating optics 20 to a mirror 18, which can be either fixed or mounted on a stage with controlled motion. The beams reflected from sample 16 and mirror 18 are recombined by beam splitter 14 and the three modulated wavelength signals are then measured in parallel using a single detector 22 while the different required phase shifts are performed sequentially by changing the phase shift introduced by the phase modulating optics 20. The intensity of each of the phase shifted signals for each wavelength is extracted in frequency demodulation unit 24 by a process of frequency domain demodulation known in the art such as by Fourier transform or using electronic bandpass filters and the three demodulated signals are sent for further processing and display to processor and display unit 26.

In embodiments of the system shown in FIG. 1, the frequency domain demodulation unit and the processor and display unit are implemented as a single combined unit that shares processing, memory, and display components.

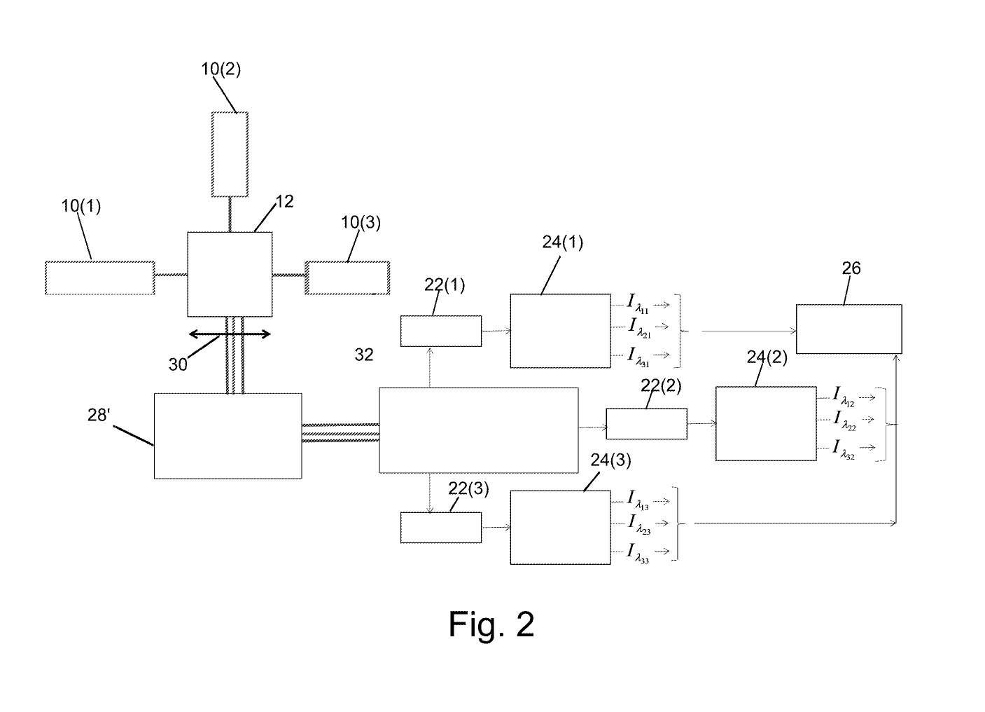

FIG. 2 schematically illustrates an embodiment of a system that uses three separate detectors and an orthogonally polarized phase shift interferometer used in a parallel detection approach (see U.S. Ser. No. 15/260,398) for carrying out the method of the invention.

In this embodiment light at wavelengths λ(1), λ(2), and λ(3) emitted by three monochromatic light sources 10(1), 10(2), and 10(3) are each modulated respectively by three well separated and different frequencies f(1), f(2) and f(3). The output intensity of each light source has the form shown in equation 5. The sources are then combined by beam combining optics 12 into a single beam that functions as the light source for two beam orthogonal polarization interferometer 28. The combined beam travels through optical elements 30 to interferometer 28′. For example, optical elements 30 can comprise one or more of the following components: a polarizer, a polarized beam splitter and an achromatic quarter wave plates; grating based polarized splitting elements; a Wollaston prism; a Rochon polarizer; polarization conversion mirrors; and a combination of achromatic waveplates and liquid crystal devices. In addition to introducing optical elements 30, the beam splitter 14 in interferometer 28 (see FIG. 1) is replaced with a polarized beam splitter and phase modulating optics 20 are removed in order to convert phase shift interferometer 28 into orthogonally polarized phase shift interferometer 28′. The single output beam from interferometer 28′ travels to beam splitting unit 32 that comprises optical components including achromatic waveplates, polarizers and beam splitting optics that split the single beam into three different phase shifted channels. From beam splitting unit 32 each channel passes through its respective detector 22(1), 22(2), and 22(3) and corresponding frequency demodulator unit 24(1), 24(2), and 24(3) to obtain intensities for each of the three wavelengths with their matching frequencies at each of the three phase shifts. Finally all nine demodulated signals are transmitted to processor and display unit 26.

A common path orthogonal polarization interferometer is another embodiment of an optical system for which the method of the invention can be used. For example when a polarized beam passes through or is reflected from a birefringent element, it splits into two orthogonally polarized beams which nearly traverse the same path and may be considered as common path interferometers when the beams are recombined. When the beam is incident at normal incidence the two orthogonally polarized components traverse exactly the same path, yet their phases are different. In nematic liquid crystal devices the extraordinary phase can be modified using an applied voltage while the ordinary one which can be considered as a reference beam is not changed. Another configuration is when a polarized beam is obliquely incident on isotropic medium composed of a single interface or multiple interfaces. In this case the reflected or transmitted TE and TM waves accumulate different phases but traverse the same path; hence after recombining the two beams using a polarizing element, this configuration acts like a common path orthogonal polarization interferometer. This last configuration is used in ellipsometry as a methodology to measure the refractive indices and thicknesses of layers.

Herein embodiments of the invention are described using three different wavelengths with the different wavelengths coming from three different sources and therefore they do not interfere. However in general the invention can be carried out using at least two different wavelengths. Alternatively two of the wavelengths or more can originate from the same light source but their beat modulation frequency will be chosen to be much higher than the detector cutoff frequency so that no extra time modulation is observed by the detector except for the modulation frequencies fₖ. In these cases the intensity pattern on each detector for each of the phase shifts denoted by I, is a sum of the three interferometric signals resulting from the interferometric signals (denoted by k) of the three wavelengths as is given in equation 6, which result from a combination of equations 2 and 5.

$${I}_{i} ( t ) = {\sum }_{k}^{ } [ {B}_{k} + {A}_{k} cos ( {φ}_{k} + ( i - 1 ) π / 2 ) ] \cdot sin ( 2 π {f}_{k} t ) \qquad ( 6 )$$

By taking the Fourier transform of equation 6 a frequency domain signal is received that is composed of the three delta function pairs around frequencies f(1), f(2) and f(3) each having an amplitude which is the Fourier transform of the corresponding term in the squared brackets in equation 6 as is given in equation 7.

$$F \{ [ {B}_{k} + {A}_{k} cos ( {φ}_{k} + ( i - 1 ) π / 2 ) ] \} * \frac{π}{j} ( δ ( ω - 2 π {f}_{k} ) + δ ( ω + 2 π {f}_{k} ) ) \qquad ( 7 )$$

By filtering each of the frequencies fₖ using a band-pass filter around each of the frequencies, the amplitude can be measured and the interferometric signal extracted for each of the wavelengths λₖ.

This in turn allows the phase for each wavelength to be extracted as it is done in the regular PSI, and combining them to extract the unwrapped phase allowing measuring larger height differences and longer movements based on the inventor's multiple wavelengths PSI technique. The frequency demodulation can be done algorithmically using Fourier transform or electronically using band-pass filtering hardware.

In another embodiment a parallel or segmented detector can be used with achromatic phase retardation mask and polarizer in front of its segments so that each segment receives interference signal that has undergone one specific phase retardation shift. A camera can be used with periodic phase retardation mask and polarizer to obtain phase shift imaging with phase unwrapping using multiple wavelengths. The phase mask can be made of achromatic liquid crystal waveplates for example or subwavelength gratings with different thicknesses, refractive indices or grating periods so that they produce different form birefringence which in turn produces the phase retardation shifts.

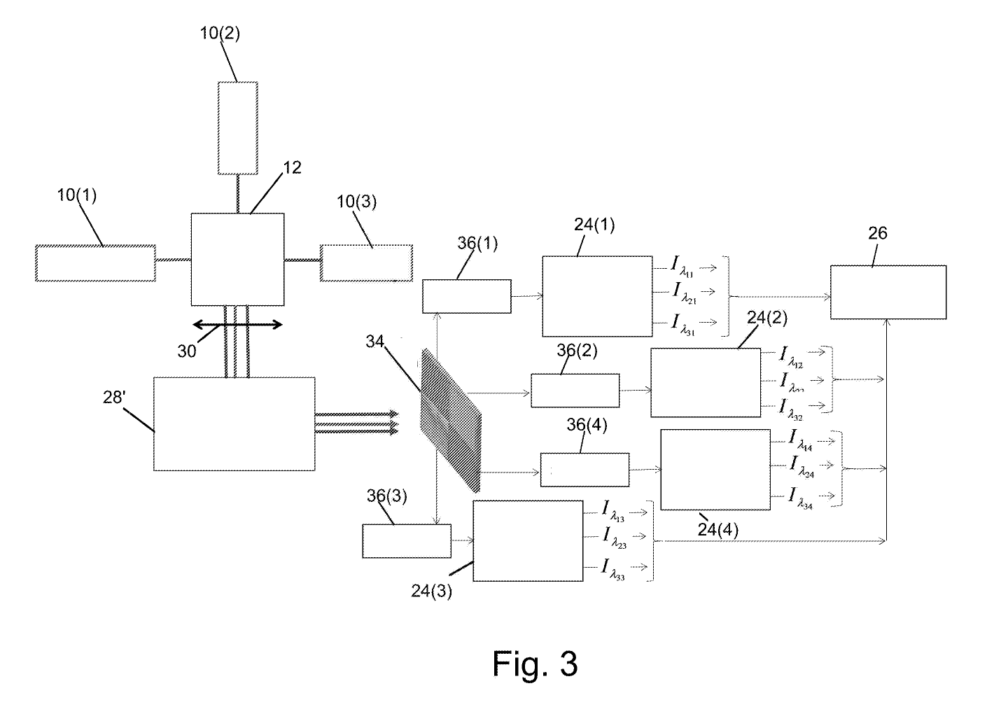

FIG. 3 schematically shows an embodiment of a system that uses a four segment detector to carry out the method of the invention. In the embodiment shown in FIG. 3 light at wavelengths λ(1), λ(2), and λ(3) emitted by three monochromatic light sources 10(1), 10(2), and 10(3) are each modulated respectively by three well separated and different frequencies f(1), f(2) and f(3). The output intensity of each light source has the form shown in equation 5. The sources are then combined by beam combining optics 12 into a single beam that functions as the light source for two beam orthogonal polarization interferometer 28′. The combined beam travels through optical elements 30 to interferometer 28′. The single output beam from interferometer 28′ passes to a detection unit 34. Detection unit 34 comprises a segmented detector and a phase mask and polarizer in front of each segment of the detector. The signals from each of segments 36(1), 36(2), 36(3), and 36(4) are demodulated separately by respective demodulation units 24(1), 24(2), 24(3), and 24(4) and the 12 signals obtained are sent to processor and display unit 26 for processing and display.

In the system shown in FIG. 3 a polarization mask, which comprises polarization axes each of which is oriented at a different angle, can be located in front of each segment of the segmented detector in place of the polarizer and the phase retardation mask. The polarization mask comprises polarization axes having at least three orientations in each segment. For example the at least three orientations can be 0, 45 and 90 degrees or −45, 0 and 45 degrees or 30, 60 and 120 degrees or other combinations.

In another variation of the system shown in FIG. 3 the segmented detector is a parallel detector or camera with a polarization mask in front of its photo sensing pixels. The polarization mask is divided into regions of 4 pixels, wherein the polarization mask comprises a polarizer having a different orientation for each of the 4 pixels. The orientations can be, for example, 0, 45, −45 and 90 degrees or other combinations. The polarizers can be for example made of wire grid type polarizers.

In embodiments of the systems shown in FIG. 2 and FIG. 3 the functions of the several frequency domain demodulation units can be carried out using one frequency domain demodulation unit configured to carry out the demodulation for signals from all channels/segments.

The systems shown in FIGS. 1-3 can be generalized as follows: In phase shift interferometry there is a need for at least 3 phase shifted signals for each of wavelengths in order to extract the desired position information of the sample under test. If the application is based on M phase shifts then there can be between M channels (at each of them all of the wavelengths' signals are phase shifted) and M×N channels where each wavelength is phase shifted separately. FIG. 1 illustrates a system in which N=3 and M phase shifts for all three signals are generated sequentially in the single channel by the phase modulating optics in the interferometer in order to acquire the phase information for the three signals. FIG. 2 illustrates a system in which N=3, M=3, and there are three channels resulting in nine signals to be processed to extract the required phase information. FIG. 3 illustrates a system in which N=3, M=4, and there are four channels resulting in twelve signals to be processed to extract the required phase information. The systems of FIG. 2 and FIG. 3 produce M sets of N signals with different wavelengths but with the same phase shift within each set; or, looked at another way, for each of the N wavelengths M phase shifted signals are produced for the same wavelength.

Using the system of FIG. 1, the M×N signals are acquired sequentially for all N wavelengths using a single detector in each one of M iterations. Using the systems of FIGS. 2 and 3, the M×N signals are acquired in a single shot for all N wavelengths using a single detector for each of the M channels.

The method of the invention and the embodiments of systems described above can advantageously be employed to:
1. build a fast 3D interferometric imaging system for fast 3D high resolution topographic mapping of the surface of samples with topographies from sub-nm up until ten of microns and more; and
2. to build a fast vibrometer or movement tracking system for tracking the position of a sample along the optical axis of the system.

Although embodiments of the invention have been described by way of illustration, it will be understood that the invention may be carried out with many variations, modifications, and adaptations, without exceeding the scope of the claims.

1. A method for performing multiple wavelength phase shift interferometry (PSI), the method comprising:
a) providing at least one light source, wherein all light sources together provide N beams of monochromatic light at N distinct wavelengths, wherein N≥2;
b) modulating each of the N monochromatic light beams with a different carrier frequency;
c) combining the N monochromatic light beams into a combined light beam comprised of the N wavelengths;
d) passing the combined light beam through an interferometer;
e) detecting the combined light beam output signal of the interferometer using at least one detector configured to detect all N wavelengths;
f) separating, by a process of frequency domain demodulation, the interferometric signal output by the at least one detector into N signals, each containing information related to a different one of the wavelengths;
g) repeating steps “e” to “f” for M different specific phase shifts for all N wavelengths produced by phase modulation optics; and
h) processing M×N signals to extract phase information for optical path difference calculations and phase unwrapping.

2. The method of claim 1 wherein at least two of the N wavelengths originate from the same light source and their beat modulation frequencies are chosen to be much higher than the detector cutoff frequency.

3. The method of claim 1 wherein the process of frequency domain demodulation comprises one of:
a) Using N electronic band pass filters; and
b) Fourier analysis.

4. The method of claim 1 wherein:
a) In step “d” the interferometer is a two beam phase shift interferometer;
b) a single detector configured to detect all N wavelengths is used to detect the combined light beam output signal of the interferometer; and
c) in step “g” the phase modulation optics are located in the two beam phase shift interferometer.

5. The method of claim 1 wherein:
a) in step “d” the interferometer is an orthogonally polarized phase shift interferometer;
b) between step “d” and step “e” the combined light beam output signal of the interferometer is passed through a beam splitting unit that comprises achromatic waveplates, polarizers and beam splitting optics that split the combined light beam into M different phase shifted channels;
c) in step “e” the combined light beam is detected with M detectors one for each of the M channels;
d) step “f” is carried out separately for the output signals from each of the M detectors; and
e) step “g” is not carried out.

6. The method of claim 1 wherein:
a) in step “d” the interferometer is an orthogonally polarized phase shift interferometer;
b) in step “e” the combined light beam output signal of the interferometer is detected by a segmented detector comprised of M segments, wherein a polarizer and a phase retardation mask, each shifting the phase by a different amount, are located in front of each segment of the detector;
c) step “f” is carried out separately for the output signals from each of the M segments; and
d) step “g” is not carried out.

7. A system for performing multiple wavelength phase shift interferometry (PSI), the system comprising:
a) at least one light source, wherein all light sources together provide N beams of monochromatic light at N distinct wavelengths, wherein N≥2;
b) components configured to modulate each of the N monochromatic light beams with a different carrier frequency;
c) beam combining optics that combine the N monochromatic light beams into a combined light beam comprising the N wavelengths;
d) an interferometer;
e) at least one detector configured to detect all N wavelengths in the combined light beam output signal of the interferometer;
f) at least one frequency domain demodulation unit configured to separate the interferometric signal output by the at least one detector into N signals, each containing information related to a different one of the wavelengths;
g) phase modulation optics configured to produce M different specific phase shifts for all N wavelengths; and
h) a processor and display unit comprising software algorithms and processing, memory, and display components configured to process M×N signals to extract phase information for optical path difference calculations and phase unwrapping.

8. The system of claim 7 wherein the frequency domain demodulation unit comprises one of:
a) N electronic band pass filters; and
b) a processor and software configured to perform Fourier analysis.

9. The system of claim 7 wherein the frequency domain demodulation unit and the processor and display unit are implemented as a single combined unit that shares processing, memory, and display components.

10. The system of claim 7 wherein at least two of the N wavelengths originate from the same light source and their beat modulation frequencies are chosen to be much higher than the detector cutoff frequency.

11. The system of claim 7 wherein:
a) the interferometer is a two beam phase shift interferometer;
b) the at least one detector is a single detector; and
c) the phase modulation optics are located in the two beam phase shift interferometer.

12. The system of claim 7 wherein:
a) the interferometer is an orthogonally polarized phase shift interferometer;
b) a beam splitting unit is located after the interferometer, the beam splitting unit comprising achromatic waveplates, polarizers and beam splitting optics that split the combined output beam from the interferometer into M different phase shifted channels, each channel comprising all N wavelengths having the same phase;
c) the one or more detectors are M detectors, each detector configured to detect all N wavelengths in a different one of each of the M channels; and
d) the at least one frequency domain demodulation unit comprises one of:
i) M frequency domain demodulation units, one for each channel; and
ii) one frequency domain demodulation unit configured to carry out the demodulation for signals from all M channels.

13. The system of claim 7 wherein:
a) the interferometer is an orthogonally polarized phase shift interferometer;
b) the one or more detectors is a segmented detector comprised of M segments, wherein a polarizer and a phase retardation mask, each shifting the phase by a different amount, is located in front of each segment of the segmented detector; and
c) the at least one frequency domain demodulation unit comprises one of:
i) M frequency domain demodulation units, one for each segment; and
ii) one frequency domain demodulation unit configured to carry out the demodulation for signals from all M segments.

14. The system of claim 13 wherein:
a polarization mask, which comprises polarization axes each of which is oriented at a different angle, is located in front of each segment of the segmented detector in place of the polarizer and the phase retardation mask.

15. The system of claim 14 wherein the polarization mask s comprises polarization axes having at least three orientations in each segment.

16. The system of claim 15 wherein the at least three orientations are one of: 0, 45 and 90 degrees; or −45, 0 and 45 degrees; and 30, 60 and 120 degrees.

17. The system of claim 14 wherein the segmented detector is a parallel detector or camera with a polarization mask in front of its photo sensing pixels, the polarization mask divided into regions of 4 pixels, wherein the polarization mask comprises a polarizer having a different orientation for each of the 4 pixels.

18. The system of claim 14 wherein the orientations are 0, 45, −45 and 90 degrees.
